(19) United States
(12) Patent Application Publication
(10) Pub. No.: US 2026/0367984 A1
(43) Pub. Date: Nov. 19, 2026

(54) Workload Management using Fuzzy Hashing of Execution Plans to Predict Resource Requirements for Data Processing Engines

(71) Applicant: International Business Machines Corporation, Armonk, NY (US)

(72) Inventors: Ying Cao, Beijing (CN); Yin Xia, Beijing (CN); Peng Hui Jiang, Beijing (CN); Jun Su, Beijing (CN)

(21) Appl. No.: 19/211,468

(22) Filed: May 19, 2025

(51) Int. Cl. G06F 9/50

(52) U.S. Cl. CPC G06F 9/5044

(57) ABSTRACT

A method for managing processing of requests. A computer system receives a request. The computer system determines a node fingerprint for the nodes in an execution plan for processing the request. The computer system determines an edge fingerprint for the edges in the execution plan for processing the request. The computer system compares the node fingerprint and the edge fingerprint with node fingerprints and edge fingerprints for historical requests to form a comparison. The computer system predicts resource requirements for processing the request based on the comparison.

### BACKGROUND

The disclosure relates generally to an improved computer system and more specifically to predicting resource requirements for process requests in data processing engines.

Data processing engines are used to handle large amounts of data for different purposes including data retrieval and data transformation. Data processing engines can process data in real time, analyze historical data, or perform other operations in response to receiving requests. Data processing engines can include, for example, structured query language (SQL) query engines, batch processing engines, steam processing engines, graphic processing engines, search engines, and other types of data processing engines.

Data processing engines receive requests to process queries or tasks. In response to receiving a query, the query is parsed and an execution plan is created to process the query. The execution plan can be optimized based on data location, resource availability, and query complexity. The data processing engine then executes the execution plan using processing resources. Results of this processing are returned to the requestor.

### SUMMARY

According to one illustrative embodiment, a method for managing processing of requests. A computer system receives a request. The computer system determines a node fingerprint for nodes in an execution plan for processing the request. The computer system determines an edge fingerprint for edges in the execution plan for processing the request. The computer system compares the node fingerprint and the edge fingerprint with node fingerprints and edge fingerprints for historical requests to form a comparison. The computer system predicts resource requirements for processing the request based on the comparison. According to other illustrative embodiments, a computer system and a computer program product for managing processing or requests are provided.

### BRIEF DESCRIPTION OF THE DRAWINGS

FIG. 1 is a block diagram of a computing environment in accordance with an illustrative embodiment;

FIG. 2 is a block diagram of a query environment in accordance with an illustrative embodiment;

FIG. 3 is a dataflow for processing requests in accordance with an illustrative embodiment;

FIG. 4 is a dataflow for predicting resource requirements for requests in the form of queries in accordance with an illustrative environment;

FIG. 5 is a flowchart of a process for generating a node fingerprint in accordance with an illustrative embodiment;

FIG. 6 is a flowchart of a process for generating a node fingerprint in accordance with an illustrative embodiment;

FIG. 7 is a flowchart of a process for matching directed acyclic graphs in accordance with an illustrative embodiment;

FIG. 8 is a flowchart of a process for managing resources for processing requests in accordance with an illustrative embodiment;

FIG. 9 is a flowchart of a process for determining an execution plan in accordance with an illustrative embodiment;

FIG. 10 is a flowchart of a process for scheduling a request in accordance with an illustrative embodiment;

FIG. 11 is a flowchart of a process for dispatching requests in accordance with an illustrative embodiment;

FIG. 12 is a flowchart of a process for predicting resource requirements in accordance with an illustrative embodiment;

FIG. 13 is a flowchart of a process for adjusting historical resources in accordance with an illustrative embodiment;

FIG. 14 is a flowchart of a process for predicting resource requirements in accordance with an illustrative embodiment;

FIG. 15 is a flowchart of a process for determining a node fingerprint in accordance with an illustrative embodiment;

FIG. 16 is a flowchart of a process for determining an edge fingerprint in accordance with an illustrative embodiment; and

FIG. 17 is a block diagram of a data processing system in accordance with an illustrative embodiment.

### DETAILED DESCRIPTION

A computer implemented method is provided for managing processing of requests. A computer system receives a request. The computer system determines a node fingerprint for nodes in an execution plan for processing the request. The computer system determines an edge fingerprint for edges in the execution plan for processing the request. The computer system compares the node fingerprint and the edge fingerprint with node fingerprints and edge fingerprints for historical requests to form a comparison. The computer system predicts resource requirements for processing the request based on the comparison. As a result, the illustrative embodiments provide a technical effect of managing processing of requests using fingerprints of an execution plan in a manner that avoids a need for exact matching with prior execution plans.

In the illustrative embodiments, the computer system determines the execution plan for the request in response to receiving the request. The execution plan comprises the nodes and the edges connecting the nodes. As result, the illustrative embodiments can provide a technical effect of creating an execution plan with nodes and edges. Thus, the illustrative embodiments can provide a technical effect of creating execution plans having nodes and edges.

In the illustrative embodiments, the computer system schedules processing of the request based on the resource requirements predicted for processing the request. As result, the illustrative embodiments can provide a technical effect of scheduling requests using predicted resource requirements.

In the illustrative embodiments, the computer system classifies tasks for performing the request to form a classification of the tasks in response to scheduling the request. The computer system dispatches the tasks for the request based on the classification of the tasks. Thus, the illustrative embodiments can provide a technical effect of dispatching tasks for the request.

In the illustrative embodiments, predicting the resource requirements for processing the request comprises the computer system identifies a prior request having a recorded node fingerprint and a recorded edge fingerprint in the comparison with a similarity metric within a similarity threshold of the node fingerprint and the edge fingerprint. The computer system predicts the resource requirements for the request using historical resources used to process the prior request. As result, the illustrative embodiments can provide a technical effect of predicting the resource requirements for the request using historical resources.

In the illustrative embodiments, the computer system adjusts the historical resources based on actual resource usage from processing the request. Thus, the illustrative embodiments can provide a technical effect of adjusting historical resources.

In the illustrative embodiments, predicting the resource requirements for processing the request comprises the computer system predicting the resource requirements for the request using a fallback mechanism in response to an absence of a prior request having a recorded node fingerprint and a recorded edge fingerprint in the comparison with a similarity metric within a similarity threshold of the node fingerprint and the edge fingerprint. As result, the illustrative embodiments can provide a technical effect of predicting resource requirements using a fallback mechanism.

In the illustrative embodiments, determining the node fingerprint comprises the computer system identifying properties of each node. The computer system constructs n-grams for each node, wherein the n-grams represent groupings of node properties. The computer system generates initial hashes for the n-grams for each node. The computer system aggregates the initial hashes generated for each node to form the node fingerprint. Thus, the illustrative embodiments can provide a technical effect of determining node fingerprints using n-grams.

In the illustrative embodiments, determining the edge fingerprint comprises the computer system constructing a bitmap for each edge in the edges to form bitmaps for edges, wherein each bitmap represents properties of an edge. The computer system aggregates the bitmaps for the edges to form the edge fingerprint. As result, the illustrative embodiments can provide a technical effect of determining edge fingerprints using an aggregation of bitmaps for edges.

A computer system comprises a processor set; a set of one or more computer-readable storage media; and program instructions, collectively stored in the set of one or more storage media to cause the processor set to perform operations. The processor set receives a request. The processor set determines a node fingerprint for the nodes in an execution plan for processing the request. The processor set determines an edge fingerprint for edges in the execution plan for processing the request. The processor set compares the node fingerprint and the edge fingerprint with node fingerprints and edge fingerprints for historical requests to form a comparison. The processor set predicts resource requirements for processing the request based on the comparison. As a result, the illustrative embodiments provide a technical effect of managing processing of requests using fingerprints of an execution plan in a manner that avoids a need for exact matching with prior execution plans.

In the illustrative embodiments, the processor set determines the execution plan for the request in response to receiving the request. The execution plan comprises the nodes and the edges connecting the nodes. Thus, the illustrative embodiments can provide a technical effect of creating execution plans having nodes and edges.

In the illustrative embodiments, the processor set schedules processing of the request based on the resource requirements predicted for processing the request. As result, the illustrative embodiments can provide a technical effect of scheduling requests using predicted resource requirements.

In the illustrative embodiments, the processor set classifies tasks for performing the request to form a classification of the tasks in response to scheduling the request. The processor set dispatches the request based on the classification of the tasks. Thus, the illustrative embodiments can provide a technical effect of dispatching tasks for the request.

In the illustrative embodiments, as part of predicting the resource requirements for processing the request the processor set identifies a prior request having a recorded node fingerprint and a recorded edge fingerprint in the comparison with a similarity metric within a similarity threshold of the node fingerprint and the edge fingerprint. The process or set predict the resource requirements for the request using historical resources used to process the prior request. As result, the illustrative embodiments can provide a technical effect of predicting the resource requirements for the request using historical resources.

In the illustrative embodiments, the processor set adjusts the historical resources based on actual resource usage from processing the request. Thus, the illustrative embodiments can provide a technical effect of adjusting historical resources.

In the illustrative embodiments, as part of predicting the resource requirements for processing the request, the processor set predicts the resource requirements for the request using a fall back mechanism in response to an absence of a prior request having a recorded node fingerprint and a recorded edge fingerprint in the comparison with a similarity metric within a similarity threshold of the node fingerprint and the edge fingerprint. As result, the illustrative embodiments can provide a technical effect of predicting resource requirements using a fallback mechanism.

In the illustrative embodiments, determining the node fingerprint comprises the processor set identifying properties of each node. The processor set constructs n-grams for each node, wherein the n-grams represent groupings of node properties. The processor set generates initial hashes for the n-grams for each node. The processor set aggregates the initial hashes generated for each node to form the node fingerprint. Thus, the illustrative embodiments can provide a technical effect of determining node fingerprints using n-grams.

In the illustrative embodiments, determining the edge fingerprints comprises the processor set constructing a bitmap for each edge in the edges to form bitmaps for the edges, wherein each bitmap represents attributes of an edge. The processor set aggregates the bitmaps for the edges to form the edge fingerprint. As result, the illustrative embodiments can provide a technical effect of determining edge fingerprints using an aggregation of bitmaps for edges.

A computer program product manages processing of requests. The computer program product comprises a set of one or more computer-readable storage media; and program instructions stored on the set of one or more storage media to perform operations. The operations comprise determining a node fingerprint for the nodes in an execution plan for processing the request. The operations comprise determining an edge fingerprint for the edges in the execution plan for processing the request. The operations comprise comparing the node fingerprint and the edge fingerprint with node fingerprints and edge fingerprints for historical requests to form a comparison. The operations comprise predicting resource requirements for processing the request based on the comparison. As a result, the illustrative embodiments provide a technical effect of managing processing of requests using fingerprints of an execution plan in a manner that avoids a need for exact matching with prior execution plans.

In the illustrative embodiments, the operations further comprise determining the execution plan for the request in response to receiving the request, wherein the execution plan comprises the nodes and the edges connecting the nodes. Thus, the illustrative embodiments can provide a technical effect of creating execution plans having nodes and edges.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

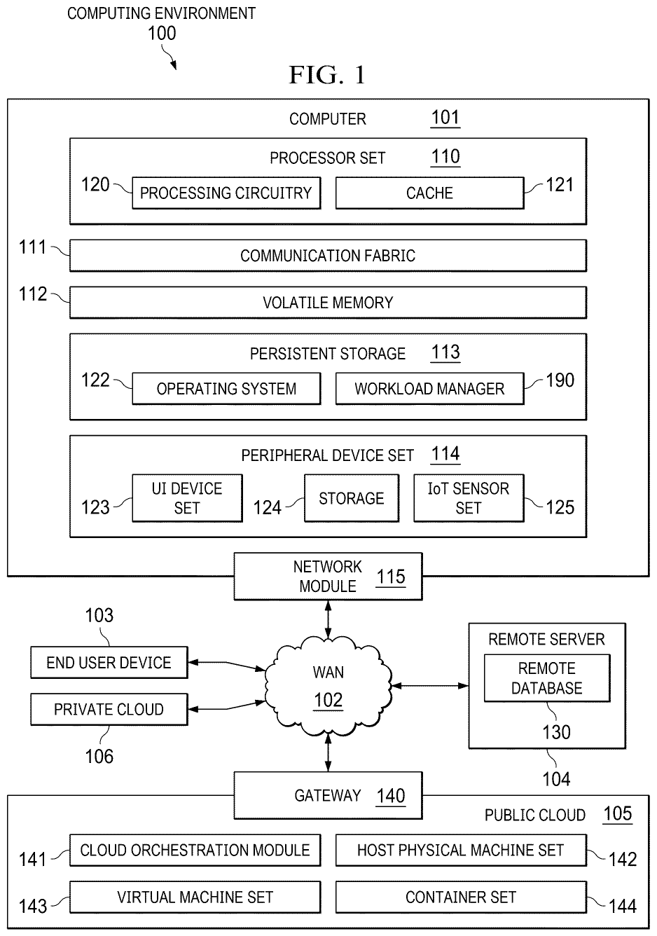

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as workload manager 190. This component manages the execution accordance in data processing engines. In addition to workload manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and workload manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in workload manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in workload manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, efficient workload management and admission control in data processing engines depend on accurately predicting resource requirements. Thes resource requirements can include, for example, CPU, memory, and I/O of incoming queries.

A workload management system can use historical execution data to make predictions of resources needed to execute requests such as queries. A prediction of resources needed to process a query uses an exact hashing of a query's execution plan. This hashing of the execution plan is often represented as a directed acyclic graph (DAG). The directed acyclic graph is matched to previously executed directed acyclic graphs for execution plans for prior queries. This type of resource prediction, however, is an exact matching technique that fails to predict resource requirements for new or slightly modified queries. As a result, this type of workload management system cannot generalize across similar queries with minor differences. As a result, unpredictable throughput can occur.

Rule-based models can be used. These models are based on query characteristics to estimate resource usage. These characteristics can include join types, table sizes, and other characteristics. This type of model requires manual tuning and subject matter experts with knowledge of particular domains for generation of rules. As a result, this type of model lacks adaptability to changing query patterns and data distributions. This type of workload management can struggle with complex queries and nonstandard workloads.

Machine learning-based predictive models can also be used to predict resource requirements. These types of machine learning models are trained using features extracted from execution plans for the queries and historical data. Although this type of model can be useful, the accuracy depends heavily on the availability of large amounts of historical data. Further, these models can fail to provide accurate resource predictions when encountering queries that are significantly different from training data. Also, model drift can occur requiring frequent retraining.

A similarity-based query matching system can also be used. This type of system clusters or classifies queries based on plan or textual similarity. The similarity metrics used are often coarse-grained and fail to capture nuanced structural variations in execution plans. Further, the matching typically depends on superficial features and does not provide deep structural analysis.

These types of systems for picking resource usage for workload management have systemic limitations. These types of predictions mechanisms lack adaptability to changing data distributions, failing to adjust to variations in data volume, distribution, or skew at runtime; they do not provide confidence assessment mechanisms, making it difficult to gauge prediction reliability. Further, these systems do not provide an ability to decide when to apply fallback strategies. Further scalability challenges are present as the number of historical query plans grows, leading to performance bottlenecks during real-time matching; and they struggle to handle unique or anomalous queries, resulting in unreliable resource estimates and unpredictable system behavior. Consequently, a need for a more adaptable, scalable, and robust solution is present.

Thus, the illustrative examples provide a computer implemented method, an apparatus, a system, and a computer program product for predicting resources needed for executing queries in data processing engines.

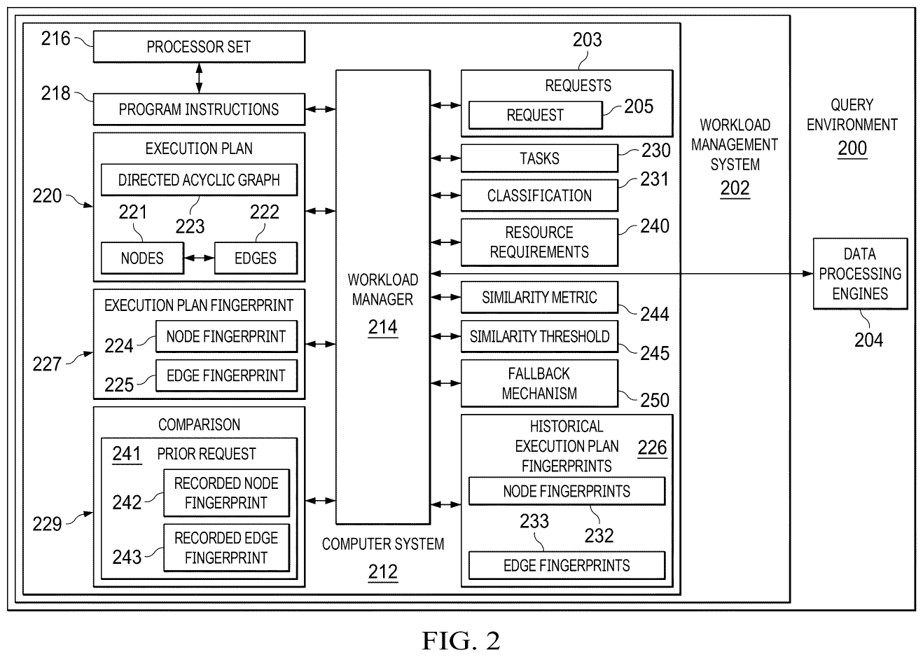

With reference now to FIG. 2, a block diagram of a query environment is depicted in accordance with an illustrative embodiment. In this illustrative example, query environment 200 includes components that can be implemented in hardware such as the hardware shown in computing environment 100 in FIG. 1. In this example, workload management system 202 operates to predict resources needed to process requests 203. These requests can take a number of forms. For example, requests 203 can be select from at least one of a query, a task, a job, or other type of request that uses resources to process the request.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In these examples, workload management system 202 can also operate to distribute requests 203 in processing requests 203 using a number of data processing engines 204 in response to predicting the resources needed. As used herein, “a number of” when used with reference to items, means one or more items. For example, “a number of operations” is one or more operations. In this example, the distribution of a request is a distribution of the tasks used to process the request.

In this illustrative example, workload management system 202 comprises computer system 212 and workload manager 214. Workload manager 214 is located in computer system 212. Workload manager 214 may be implemented using workload manager 190 in FIG. 1.

In this illustrative example, workload manager 214 can be implemented in software, hardware, firmware or a combination thereof. When software is used, the operations performed by workload manager 214 can be implemented in program instructions configured to run on hardware, such as a processor unit. When firmware is used, the operations performed by workload manager 214 can be implemented in program instructions and data and stored in persistent memory to run on a processor unit. When hardware is employed, the hardware can include circuits that operate to perform the operations in workload manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In one illustrative example, workload manager 214 operates to process requests 203. For example, workload manager 214 receives request 205 in requests 203 for processing. Workload manager 214 determines execution plan 220 for request 205 in response to receiving request 205. Execution plan 220 is a number of operations that defines how the request 205 will be processed. The execution plan can include the sequence of steps, data access methods, and resource allocation. This processing can include accessing, retrieving, filtering, transforming, aggregating, or other operations.

In this illustrative example, execution plan 220 takes the form of directed acyclic graph 223. This graph comprises nodes 221 and edges 222 connecting nodes 221.

Nodes 221 represent operations in the form of tasks 230. Each of tasks 230 can perform a specific operation on data. These tasks can include, for example, a table scan, a filter, a join, a projection, an aggregation, and other types of operations.

Edges 222 represent data flow and dependency relationships between tasks 230. For example, an edge connecting a source node to a target node can indicate how the output from a source node is an input to a target node. In these examples, directed acyclic graph 223 has edges 222 that provide a direction of flow indicating the execution order for nodes 221. In this example, this type of graph enforces a non-circular execution path.

In this illustrative example, workload manager 214 determines node fingerprint 224 for nodes 221 in execution plan 220 for processing request 205. Workload manager 214 also determines edge fingerprint 225 for edges 222 in execution plan 220 for processing request 205. As depicted, node fingerprint 224 and edge fingerprint 225 form execution plan fingerprint 227.

Workload manager 214 compares execution plan 220 with historical execution plan fingerprints 226 determined for previous requests that have been executed. For example, workload manager 214 compares node fingerprint 224 and edge fingerprint 225 with node fingerprints 232 and edge fingerprints 233 in historical execution plan fingerprints 226 for previous requests to form a comparison 229. This comparison can be performed using fuzzy matching. Each previous request has a historical execution plan fingerprint in historical execution plan fingerprints 226 that comprises a node fingerprint in node fingerprints 232 and a corresponding edge fingerprint in edge fingerprints 233.

Workload manager 214 predicts resource requirements 240 for processing the request 205 based on comparison 229. Resource requirements 240 can include resources selected from at least one of the necessary cycles, memory, I/O bandwidth, network bandwidth, storage space, a scheduler resource, a thread resource, or other types of resources used to process request 205 according to execution plan 220. Based on these resources, a data processing engine in data processing engines 204 can be selected for accessing request 205. This data processing engine can have the needed resources predicted by workload manager 214 or those resources can be allocated to the data processing engine.

Workload manager 214 predicts resource requirements 240 for the request using historical resources used to process the prior request. In one illustrative example, workload manager 214 identifies a prior request 241 having recorded node fingerprint 242 and recorded edge fingerprint 243 in comparison 229 with a similarity metric 244 within similarity threshold 245 of node fingerprint 224 and the edge fingerprint 225. With the use of fuzzy matching, the degree of similarity between fingerprints as represented by similarity metric 244 can be determined.

As a result, the degree of confidence can be represented by the similarity score as compared to a threshold such as similarity threshold 245. Similarity threshold 245 can be used as a measure to determine when the score represented by similarity metric 244 is sufficient to use the resource requirements for the prior request as resource requirements 240 predicted for request 205.

In this example, similarity threshold 245 can take a number of different forms. This metric can be any metric used to measure similarity between these fingerprints. For example, similarity metric 244 can be a Hamming distance. Other similarity metrics can be a Jaccard similarity, a Euclidean distance, a cosine similarity, and other suitable metrics.

Similarity threshold 245 defines how close the fingerprints should be to each other using similarity metric 244. For example, with a Hamming distance, this metric measures the number of positions at which corresponding symbols in streams of equal length are different. For example, 1011101 and 1001001 have a Hamming distance of two because the bits in these two strings differ at two bit positions.

In response to predicting resource requirements 240, workload manager 214 can schedule processing of request 205 based on resource requirements 240 predicted for processing request 205. More specifically, workload manager 214 schedules the performance of tasks 230 using directed acyclic graph 223. In this example, workload manager 214 can schedule processing of request 205 using one of data processing engines 204. The selection of the data processing engine can be made based on resource requirements 240 predicted for running execution plan 220 to process request 205. The selection can also be made based on the workloads for data processing engines 204. In these examples, the scheduling can be the scheduling of tasks 230 that are used to process request 205. These tasks are nodes 221 in execution plan 220 for request 205.

Additionally, workload manager 214 can use other mechanisms to predict resource requirements 240. For example, workload manager 214 can predict resource requirements 240 for request 205 using fallback mechanism 250 in response to an absence of prior request 241 having recorded node fingerprint 242 and recorded edge fingerprint 243 in comparison 229 with similarity metric 244 that is within similarity threshold 245 of node fingerprint 224 and edge fingerprint 225.

In this illustrative example, fallback mechanism 250 can take a number of different forms. For example, fallback mechanism 250 can be selected from the group comprising an exact hashing comparison, a rule-based estimation model, a machine learning predictive model, a similarity-based query matching system, and other suitable types of resource estimation techniques.

In this depicted example, request 205 can be dispatched for processing in a number of different ways. For example, workload manager 214 can classify tasks 230 for performing request 205 to form classification 231 of tasks 230 in response to scheduling request 205. These tasks are nodes 221 in execution plan 220. Workload manager 214 dispatches tasks 230 for request 205 based on classification 231 of tasks 230.

In another illustrative example, workload manager 214 can adjust fingerprint parameters based on actual resource usage from processing the request. For example, a feedback loop can be configured to adjust fingerprint parameters on a dynamic basis based on actual resource usage in response to processing requests. These fingerprint parameters can include at least one of a hash weight, an n-gram structure, n-gram composition, bit position sensitivity in SimHash, feature inclusion from fingerprints, feature exclusion from fingerprints, or historical resource-profile statistics for matching fingerprints. The historical resources can be adjusted for the request having fingerprints that are most similar to the current request being processed.

In one illustrative example, one or more technical solutions are present that overcome a technical problem with predicting resources needed to process requests. As a result, one or more technical solutions may provide a technical effect predicting resource requirements with a greater accuracy as compared to current techniques.

Computer system 212 can be configured to perform at least one of the steps, operations, or actions described in the different illustrative examples using software, hardware, firmware or a combination thereof. As a result, a practical application of determining resource requirements for requests can be used in a practical application that improves the operation of computer system 212 in processing requests. In these examples, workload manager 214 and computer system 212 predicts resource requirements for processing requests in a manner that is more efficient and accurate as compared to current techniques.

In the illustrative example, the use of workload manager 214 in computer system 212 integrates processes into a practical application for predicting resource requirements are used to increase the performance of computer system 212 and processing of requests. In other words, workload manager 214 in computer system 212 is directed to a practical application of processes integrated into workload manager 214 in computer system 212 that predicts resource requirements that have a practical application of being used in computer system 212 to process requests.

In these illustrative examples, workload manager 214 can process requests in a manner that provides adaptability to changing data distributions and adjust to variations in data volume, distribution, or skew at runtime. Further, workload manager 214 provides confidence in using assessment mechanisms such as similarity metrics and thresholds to increase prediction reliability. Workload manager 214 can also apply fallback strategies as needed depending on the type of request received. For example, if the request is outside of the normal distribution or does not have a prediction with a desired level of confidence, fallback mechanism 250 is used in place of the resource requirements for historical execution plan fingerprints 226.

The illustration of query environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

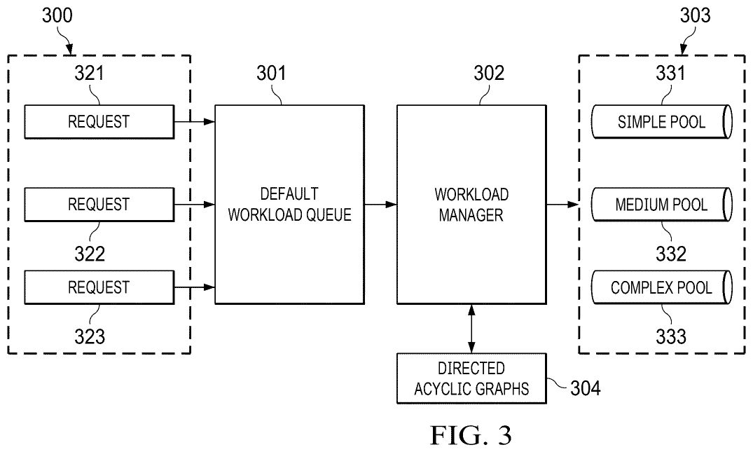

Turning to FIG. 3, a dataflow for processing requests is depicted in accordance with an illustrative embodiment. In this illustrative example, requests 300 include request 321, request 322, and request 323. Requests 300 take different forms such as queries, tasks, jobs, or other types of requests. In this example, requests 300 are collected in default workload queue 301. This queue acts as an initial staging area for processing these requests.

In this illustrative example, workload manager 302 is an example of workload manager 214 in FIG. 2. Workload manager 302 processes requests in default workload queue 301. For example, workload manager 302 predicts resources needed to process requests 300 in default workload queue 301. Further, workload manager 302 can schedule and distribute the tasks for executing these requests to resource pools 303.

In this example, 302 generates execution plans in the form of directed acyclic graphs 304 for requests 300. For example, workload manager 302 can determine tasks and execution order for the tasks as well as dependencies for tasks. This information is used to generate directed acyclic graphs 304. Each graph provides an execution plan for requests. Nodes represent the tasks. Edges connecting the nodes are used to indicate the order of execution as well as dependencies between tasks.

This information is used to schedule the execution of each of the execution plans represented by directed acyclic graphs 304. In this example, workload manager 302 can schedule the execution of tasks for requests using the directed acyclic graph for that request. These tasks can be sent to resource pools 303. The tasks can be dispatched to resource pools 303 based on complexity of the tasks. For example, depending on the classification of complexity, tasks can be sent to simple pool 331, medium pool 332, or complex pool 333.

In this example, task complexity can be determined by analyzing factors such as type of operation, volume process, expected resource usage, and dependency on other tasks. These factors can be used to assign scores to the complexity of the task. The score can then be used to indicate whether the task is simple, medium, or complex and distribute the task to the appropriate resource pool.

In one illustrative example, resource pools 303 can be in a single data processing engine. In another example, these resource pools can be allocated to multiple data processing engines. This type of setup can enable parallel processing as well as scalable processing in various environments such as cloud or cluster-based environments.

The illustration of the dataflow in FIG. 3 is one example of dataflow and is not meant to limit the manner in which other data flows can be implemented. For example, multiple workload queues can be present in some examples to receive requests. In yet other illustrative examples, other numbers of resource pools can be used such as two, five, or some other number of research pools that are divided up based on complexity of tasks.

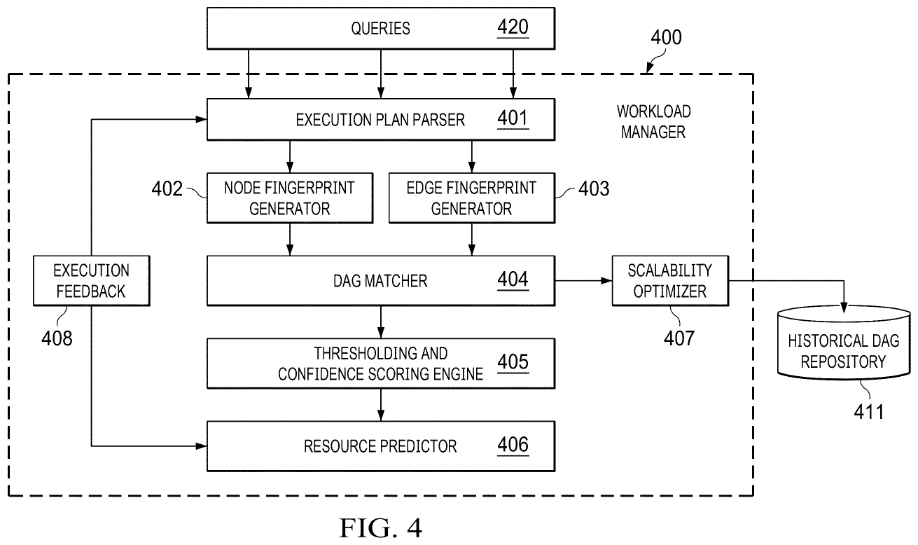

Turning now to FIG. 4, a dataflow for predicting resource requirements for requests in the form of queries is depicted in accordance with an illustrative environment. In this example, workload manager 400 is an example of an implementation for workload manager 214 in FIG. 2.

In this illustrative example, workload manager 400 is comprised of a number of different components. As depicted, workload manager 400 comprises execution plan parser 401, node fingerprint generator 402, edge fingerprint generator 403, directed acyclic graph (DAG) matcher 404, thresholding and confidence scoring engine 405, resource predictor 406, scalability optimizer 407, and execution feedback 408.

As depicted in this example, execution plan parser 401 in workload manager 400 receives requests in the form of queries 420. Each of these queries is processed by execution plan parser 401 to generate an execution plan in the form of a directed acyclic graph. In this graph, the nodes represent tasks performed for the query. The edges connect the nodes to indicate an order of execution as well as the relationship between tasks for the query.

Node fingerprint generator 402 receives the directed acyclic graph from execution plan parser 401 and processes the nodes in this graph. The processing involves hashing the nodes to form a node fingerprint for the execution plan. For example, node fingerprint generator 402 first processes the nodes in the directed acyclic graph along with the properties of the nodes to form n-grams. The properties can include operator type, estimated row count, filter conditions, property values and other properties.

In this example, node fingerprint generator 402 processes these n-grams using similarity hashing to create hashes that form a node fingerprint for the execution plan. Similarity hashing maps dimensional data into lower-dimensional “hashes” such that similar inputs produce similar hashes. This type of hashing is also referred to as locality-sensitive hashing (LSH), For example, MinHash, SimHash, LSH for Cosine Similarity.

This node fingerprint reflects both the node's attributes and its operational context. This information allows for approximate comparison of this fingerprint with nodes from previously executed directed acyclic graphs.

Edge fingerprint generator 403 also receives the directed acyclic graph from execution plan parser 401 and processes the edges in this graph. The processing by edge fingerprint generator 403 can involve creating a data structure from the edges to form an edge node fingerprint for the execution plan. These edges represent dataflow and operator dependencies. The edges are combined in a process that encodes the topological layout and the execution order of the operators into a data structure that forms an edge fingerprint. For example, the information dataflow and operator dependencies for the edges are placed into data structures and day-to-day structures are aggregated to form an edge fingerprint. This edge fingerprint ensures similarities in graph structure, even with variations in individual nodes.

Next, DAG matcher 404 receives the node fingerprint from the node fingerprint generator 402 and the edge fingerprint from the edge fingerprint generator 403. DAG matcher 404 compares these fingerprints to stored node fingerprints and stored edge fingerprints from historical executions of prior queries. These stored fingerprints are located in historical DAG repository 411.

In this example, a comparison between the node fingerprint and the edge fingerprint is made by comparing these fingerprints with stored node fingerprints and stored edge fingerprints for previously executed queries in historical DAG repository 411. In this example, comparison can be performed by DAG matcher 404 using a matching process that is performed using distance or similarity metrics, such as Hamming distance for simhash.

For example, DAG matcher 404 uses the node fingerprint generated by node fingerprint generator 402 and the edge fingerprint generated by edge fingerprint generator 403 for the execution plan to identify a prior query that has a node fingerprint and edge fingerprint stored in historical DAG repository 411 that is sufficiently similar. The resources used by that prior query can be used as a prediction of the resource requirements for the current query being processed.

In the illustrative example, thresholding and confidence scoring engine 405 generates scores for the comparisons made by DAG matcher 404. Given the nature of fuzzy matching, the potential is present for variance in similarity scores. This situation can be handled by thresholding and confidence scoring engine 405 computing a confidence score based on the degree of similarity between fingerprints.

For example, a confidence score can be calculated using the combined Hamming distances for the node fingerprint and the edge fingerprint. This confidence score can form the similarity metric for the node fingerprint and the edge fingerprint for comparison with the stored node fingerprint scan and the stored edge fingerprint for a prior query.

The scores from the different comparisons are used by resource predictor 406 to predict the resource requirements for the query. For example, the resources used from executing a prior query can be used by resource predictor 406 as the prediction of the resource requirements for the query to be executed when the score is equal to or exceeds a predefined threshold.

For cases where the similarity score falls below the threshold, resource predictor 406 can employ one or more fallback mechanisms. A fallback mechanism can be a conservative resource allocation or alternate resource estimation technique. For example, the fall back mechanism can include at least one of conservative resource allocations that can be defined using heuristic rules, predefined defaults set by a subject matter expert or system administrator, alternative estimation techniques such as rule-based or statistics-driven estimators, or other suitable techniques. These queries and their execution plans can be logged for analysis. This analysis can enable incorporating these characteristics for future fingerprint adjustments. This resource allocation can be set in a manner that increases system stability.

This fallback feature ensures robustness in predicting resource requirements to reduce the possibility of a misallocation of resources. This fallback feature can also enable handling unique or anomalous queries in which comparisons do not find a good similarity in matching fingerprints. As a result, more consistent system performance in outlier scenarios is enabled. This feature in these examples provides coverage for previously unseen queries, reduces reliance on exact plan matches, and enhances the accuracy, scalability, and adaptability of workload management systems.

As a result, resource predictor 406 can thus infer the resource requirements of the query using resources used by a prior query having fingerprints for a directed acyclic graph are sufficiently similar to the node fingerprint and the edge fingerprints. Thus, resource predictor 406 can predict resource requirements of the new query based on the known requirements of the most similar historical directed acyclic graphs.

Another feature of workload manager 400 in this example is execution feedback 408. Execution feedback 408 uses one or more feedback loops to handle evolving data distributions. For example, after executing each query, execution feedback 408 collects metrics on the actual resources used to execute the query using the execution plan. Execution feedback 408 compares the actual resources used with the prediction resources. If the difference in resources is greater than the threshold, then execution feedback 408 can suggest weights or attributes in node fingerprint generator 402 and edge fingerprint generator 403. If certain node types (e.g., joins or aggregations) consistently require more resources than predicted, the weight for those node types can be increased in the fingerprint generation process. This weight adjustment makes those node types more influential in similarity calculations.

In another example, additional attributes can be added to the fingerprint in which these attributes are related to filter selectivity or cardinality estimation. These attributes can be added if filter conditions for some queries tend to use more resources than initially anticipated. These additional attributes can be incorporated for use in future resource predictions.

Further, execution feedback 408 can store updated fingerprints in historical DAG repository 411. In this example, updated fingerprints are refined versions of node fingerprints and edge fingerprints, which are adjusted based on actual resource usage compared to predictions. These updated fingerprints are stored in the historical DAG repository 411 to improve future resource predictions for similar queries. These updated fingerprints improve prediction accuracy when similar queries are received for resource prediction.

In another illustrative example, scalability optimizer 407 can be used in workload manager 400 to employ efficient indexing techniques, such as Locality-Sensitive Hashing (LSH) or Approximate Nearest Neighbor (ANN), for rapid retrieval of historical fingerprints. This component can also operate to periodically clean and prune outdated or rarely used fingerprints from the historical DAG repository 411 to reduce storage and improve search efficiency.

Also, scalability optimizer 407 can distribute fingerprint storage and matching computations across multiple nodes in distributed systems to enhance scalability and ensure real-time responsiveness. In other words, scalability optimizer 407 can send information to other instances of workload manager 400 to increase scalability and real time responsiveness.

The illustration of workload manager 400 and different components in this workload manager in FIG. 4 is provided as one example of a workload manager and not meant to limit the manner in which other illustrative examples can be implemented. For example, one or both of execution feedback 408 and scalability optimizer 407 can be omitted in other implementations. As another example, workload manager 400 can be implemented to process other types of requests other than queries 420. For example, workload manager 400 can also be configured to process at least one of jobs, tasks, or other requests in addition to or in place of queries 420.

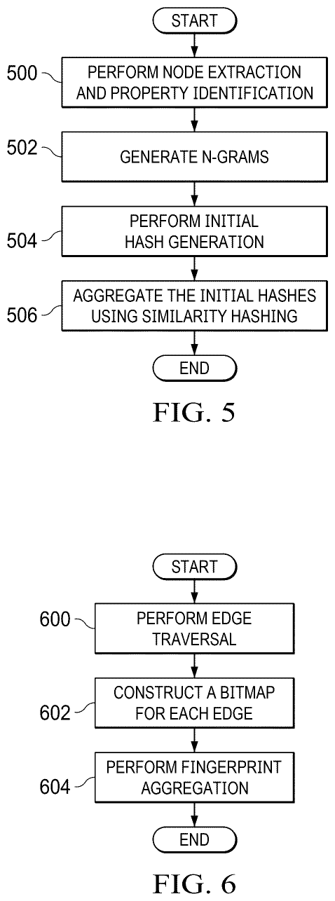

Turning next to FIG. 5, a flowchart of a process for generating a node fingerprint is depicted in accordance with an illustrative embodiment. The process in FIG. 5 can be implemented in hardware, software, or both. When implemented in software, the process can take the form of program instructions that are run by a processor set located in one or more hardware devices in one or more computer systems. For example, the process can be implemented in node fingerprint generator 402 in FIG. 4.

The process performs node extraction and property identification (step 500). In step 500, nodes are extracted from the directed acyclic graph. The properties are identified for these nodes. For example, the properties can include operator type as well as other properties. The operator type can be, for example, scan, filter join, or aggregation. Properties can include estimated load count, filter conditions, and other attributes of the node.

The process generates n-grams (step 502). In step 502, the n-grams represent sequences or groupings of the node's attributes, operator types, and property values. An n-gram for a node in a directed acyclic graph is a way to represent sequences of the node's characteristics or attributes as grouped tokens. These representations can be broken into combinations of n consecutive elements. This step captures both local and contextual information of each node in the directed acyclic graph.

The process performs initial hash generation (step 504). In this step, the process uses a fast, non-cryptographic hash function such as CityHash or MurmurHash (64-bit) to each n-gram. This hashing produces individual fixed-size hashes that uniquely represent the characteristics of each node and its context.

The process then aggregates the initial hashes using similarity hashing (step 506). The process terminates thereafter.

In step 506, all of the hashes for the nodes are aggregated using the SimHash algorithm to form the node fingerprint. In this step, h is the hash of each n-gram, and h_i represents the i-th bit of hash h. A weight W_h is assigned to each hash. In this example, W_h=1 for simplicity. For each bit position i (from 1 to 64), this step computes final[i]=Σ(W_h for all h_i=1)−Σ(W_h for all h_i=0). The step sets f_i=1 if final[i]>0, else f_i=0. The result is a single 64-bit SimHash fingerprint f for the entire node set. This fingerprint is the node fingerprint.

Thus, this process can generate a compact and descriptive fingerprint that captures the essential characteristics of all nodes within a directed acyclic graph for an execution plan for a query. In this example, the node fingerprint reflects both the properties and the contextual structure of the operators, enabling efficient comparison between different execution plans. The use of similarity hashing ensures that structurally and operationally similar queries result in fingerprints with minimal Hamming distance, facilitating approximate yet accurate matching.

With reference to FIG. 6, a flowchart of a process for generating a node fingerprint is depicted in accordance with an illustrative embodiment. The process in FIG. 6 can be implemented in hardware, software, or both. When implemented in software, the process can take the form of program instructions that are run by a processor set located in one or more hardware devices in one or more computer systems. For example, the process can be implemented in edge fingerprint generator 403 in FIG. 4.

The process begins by performing edge traversal (step 600). In step 600, the process traverses all edges in the directed acyclic graph, starting from the root node. Each edge represents the dependency and data flow between two nodes, a source node and a target node.

The process constructs a bitmap for each edge (step 602). In this step, a bitmap is constructed for each edge. The bitmap can be constructed by encoding specific properties from both the source node and target node. The bitmap can include the following attributes: node operator type (e.g., Scan, Filter, Join, Aggregation); topological forward order (number of sub-nodes below the node); topological backward order (number of parent nodes); in-degree (number of incoming edges to the node); and out-degree (number of outgoing edges from the node). In this example, each attribute occupies a fixed, predefined position in the bitmap to maintain consistency across all edges in the directed acyclic graph as well as edges in other directed acyclic graphs. This consistency enables generating fingerprints that can be compared between different directed acyclic graphs.

The process then performs fingerprint aggregation (step 604). The process terminates thereafter. This step performs binary arithmetic addition (bitwise summation) across all edge bitmaps for all of the edges. The aggregated result forms a single, fixed-size bitmap. This bitmap is the edge fingerprint and represents the overall topology and order of operations within the directed acyclic graph.

Thus, the process for generating fingerprints provides similarity assurance. By combining both edge fingerprint (graph topology) and node fingerprint (operator details), robust identification of queries with similar structural and operational characteristics can be performed even when minor variations are present between the fingerprints for different queries.

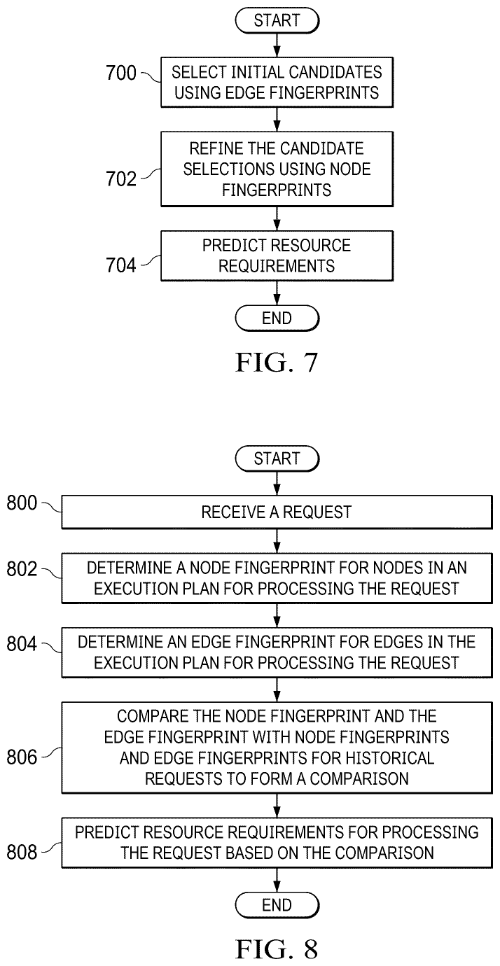

In FIG. 7, a flowchart of a process for matching directed acyclic graphs is depicted in accordance with an illustrative embodiment. The process in FIG. 7 can be implemented in hardware, software, or both. When implemented in software, the process can take the form of program instructions that are run by a processor set located in one or more hardware devices in one or more computer systems. For example, the process can be implemented in DAG matcher 404 in FIG. 4.

The process begins by selecting initial candidates using edge fingerprints (step 700). In step 700, the edge fingerprint generated for the query is compared with the stored edge fingerprints generated for previously executed queries. The selection can include using a similarity metric, such as Hamming distance, to evaluate the closeness between the edge fingerprints. In this step, the process retrieves the top k most structurally similar directed acyclic graphs based on the smallest Hamming distance.

In this flowchart, indexing mechanisms such as Locality-Sensitive Hashing (LSH) or Approximate Nearest Neighbor (ANN) search can be used for rapid retrieval of top k candidates based on edge fingerprints.

The process refines the candidate selections using node fingerprints (step 702). In this step, For each of the k candidate directed acyclic graphs, the Hamming distance is calculated between their node fingerprints and the node fingerprint for the directed acyclic graph for the query being processed. In this example, the k candidates are sorted based on the node fingerprint distances to rank the most operationally similar queries.

The process predicts resource requirements (step 704). The process terminates thereafter. In step 704, the resources required for the query being processed is predicted by aggregating the runtime characteristics of the k nearest matching directed acyclic graphs. The runtime characteristics are the types and amounts of resources actually used by the queries corresponding to the k nearest matching directed acyclic graphs (DAGs). These resources are aggregated to predict the resource requirements for the current query. This approach leverages historical execution data to enhance prediction accuracy.

A weighted average of the historical runtime data is computed, where weights are inversely proportional to the node fingerprint distances. This computation gives higher influence for directed acyclic graphs with closer matches.

Thus, by combining both edge fingerprint (graph topology) and node fingerprint (operator details), the system ensures robust identification of queries with similar structural and operational characteristics. This identification can occur even when minor variations are present between fingerprints that are being compared.

Turning next to FIG. 8, a flowchart of a process for managing resources for processing requests is depicted in accordance with an illustrative embodiment. The process in FIG. 8 can be implemented in hardware, software, or both. When implemented in software, the process can take the form of program instructions that are run by a processor set located in one or more hardware devices in one or more computer systems. For example, the process can be implemented in workload manager 214 in computer system 212 in FIG. 2.

The process begins by receiving a request (step 800). The process determines a node fingerprint for nodes in an execution plan for processing the request (step 802). The process determines an edge fingerprint for edges in the execution plan for processing the request (step 804).

The process compares the node fingerprint and the edge fingerprint with node fingerprints and edge fingerprints for historical requests to form a comparison (step 806). The process predicts resource requirements for processing the request based on the comparison (step 808). The process terminates thereafter.

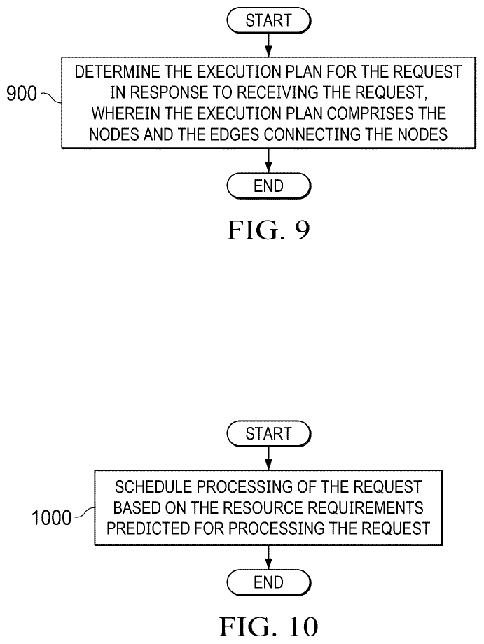

Turning now to FIG. 9, a flowchart of a process for determining an execution plan is depicted in accordance with an illustrative embodiment. The process in FIG. 9 is an example of a step that can be performed with the steps in FIG. 8.

The process determines the execution plan for the request in response to receiving the request, wherein the execution plan comprises the nodes and the edges connecting the nodes (step 900). The process terminates thereafter.

Next in FIG. 10, a flowchart a process for scheduling a request is depicted in accordance with an illustrative embodiment. The process in FIG. 10 is an example of a step that can be performed with the steps in FIG. 8.

The process schedules processing of the request based on the resource requirements predicted for processing the request (step 1000). The process terminates thereafter.

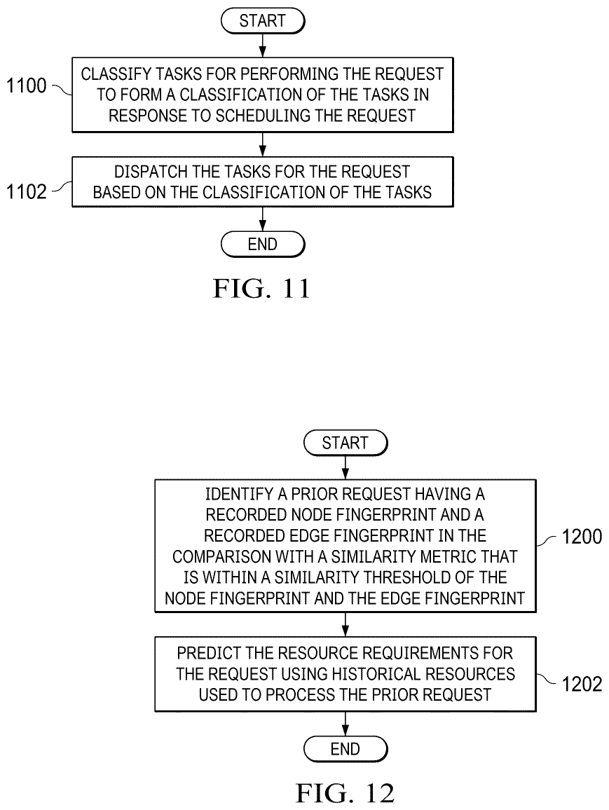

In FIG. 11, a flowchart of a process for dispatching requests is depicted in accordance with an illustrative embodiment. The process in FIG. 11 is an example of a step that can be performed with the steps in FIG. 8.

The process classifies tasks for performing the request to form a classification of the tasks in response to scheduling the request (step 1100). The process dispatches the tasks for the request based on the classification of the tasks (step 1102). The process terminates thereafter.

Turning next to FIG. 12, a flowchart of a process for predicting resource requirements is depicted in accordance with an illustrative embodiment. The process in FIG. 12 is an example of an implementation for step 806 in FIG. 8.

The process identifies a prior request having a recorded node fingerprint and a recorded edge fingerprint in the comparison with a similarity metric that is within a similarity threshold of the node fingerprint and the edge fingerprint (step 1200). The process predicts the resource requirements for the request using historical resources used to process the prior request (step 1202). The process terminates thereafter.

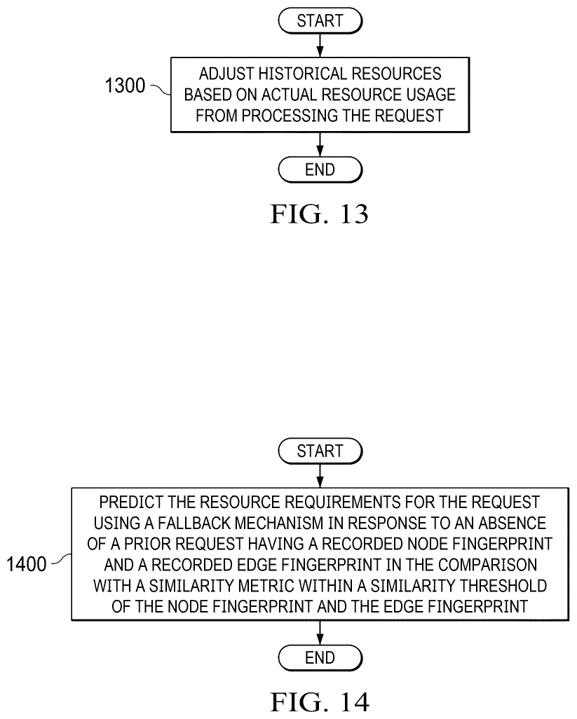

With reference now to FIG. 13, a flowchart of a process for adjusting historical resources is depicted in accordance with an illustrative embodiment. The process in FIG. 13 is an example of an implementation of an additional step that can be performed with the steps in FIG. 8.

The process adjusts historical resources based on actual resource usage from processing the request (step 1300). The process terminates thereafter. In step 1300, The adjustment of historical resources involves storing the current query and its corresponding fingerprint along with the actual resource usage as new historical data. In another example, the adjustment of historical resources involves updating the historical resources of the prior request that was used for prediction. This depends on whether the system tracks and stores the current query separately or directly modifies the existing historical data based on the actual resource usage.

Turning to FIG. 14, a flowchart of a process for predicting resource requirements is depicted in accordance with an illustrative embodiment. The process in FIG. 14 is an example of an implementation for step 806 in FIG. 8.

The process predicts the resource requirements for the request using a fallback mechanism in response to an absence of a prior request having a recorded node fingerprint and a recorded edge fingerprint in the comparison with a similarity metric within a similarity threshold of the node fingerprint and the edge fingerprint (step 1400). The process terminates thereafter.

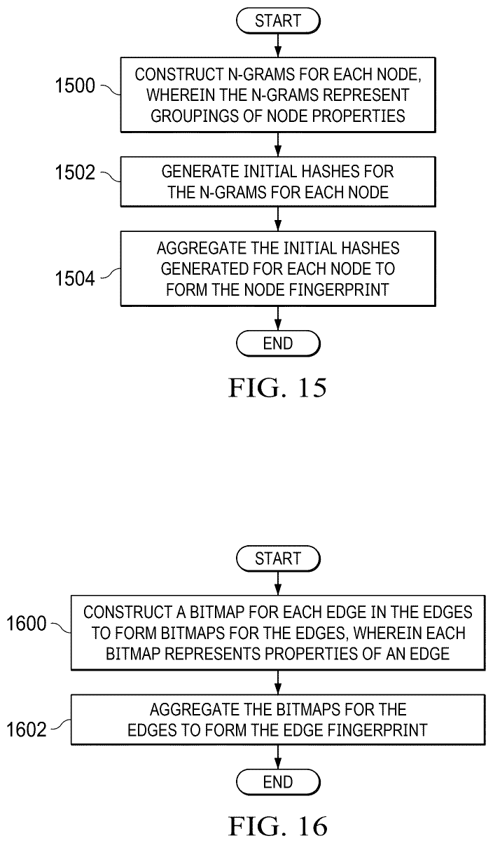

With reference next to FIG. 15, a flowchart of a process for determining a node fingerprint is depicted in accordance with an illustrative embodiment. The process in FIG. 15 is an example of an implementation for step 802 in FIG. 8.

The process constructs n-grams for each node, wherein the n-grams represent groupings of node properties (step 1500). The process generates initial hashes for the n-grams for each node (step 1502).

The process aggregates the initial hashes generated for each node to form the node fingerprint (step 1504). The process terminates thereafter.

Next in FIG. 16, a flowchart of a process for determining an edge fingerprint is depicted in accordance with an illustrative embodiment. The process in FIG. 16 is an example of an implementation for step 804 in FIG. 8.

The process constructs a bitmap for each edge in the edges to form bitmaps for the edges, wherein each bitmap represents properties of an edge (step 1600). In step 1600, the properties can be a source node and a target node of each edge. The properties can be node operator type (e.g., Scan, Filter, Join, Aggregation); Topological forward order (number of sub-nodes below the node), topological backward order (number of parent nodes), in-degree (number of incoming edges to the node); and out-degree (number of outgoing edges from the node). In this example, each property occupies a fixed, predefined position in the bitmap to maintain consistency across all edges in the directed acyclic graphs.

The process aggregates the bitmaps for the edges to form the edge fingerprint (step 1602). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

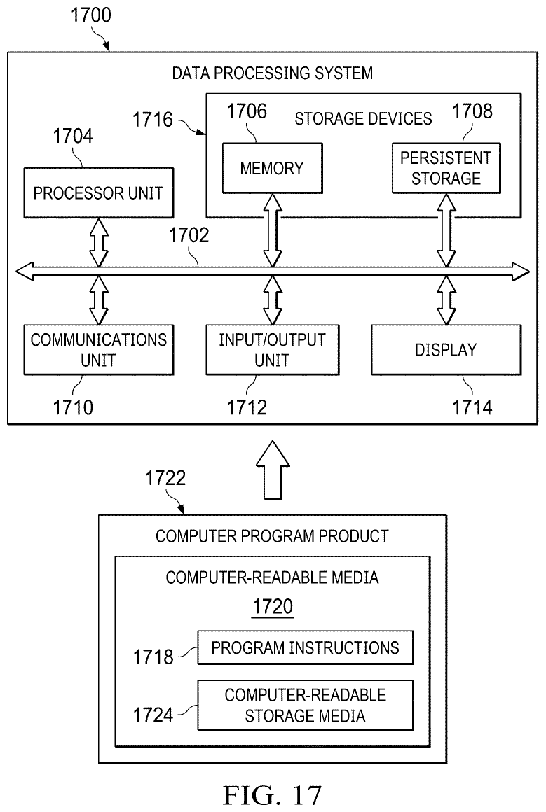

Turning now to FIG. 17, a block diagram of a data processing system is depicted in accordance with an illustrative embodiment. Data processing system 1700 can be used to implement computers and computing devices in computing environment 100 in FIG. 1. Data processing system 1700 can also be used to implement computer system 212 in FIG. 2. In this illustrative example, data processing system 1700 includes communications framework 1702, which provides communications between processor unit 1704, memory 1706, persistent storage 1708, communications unit 1710, input/output (I/O) unit 1712, and display 1714. In this example, communications framework 1702 takes the form of a bus system.

Processor unit 1704 serves to execute instructions for software that can be loaded into memory 1706. Processor unit 1704 includes one or more processors. For example, processor unit 1704 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1704 can be implemented using one or more heterogeneous processor systems in which a main processor is present with secondary processors on a single chip. As another illustrative example, processor unit 1704 can be a symmetric multi-processor system containing multiple processors of the same type on a single chip.

Memory 1706 and persistent storage 1708 are examples of storage devices 1716. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1716 may also be referred to as computer-readable storage devices in these illustrative examples. Memory 1706, in these examples, can be, for example, a random-access memory or any other suitable volatile or non-volatile storage device. Persistent storage 1708 may take various forms, depending on the particular implementation.

For example, persistent storage 1708 may contain one or more components or devices. For example, persistent storage 1708 can be a hard drive, a solid-state drive (SSD), a flash memory, a rewritable optical disk, a rewritable magnetic tape, or some combination of the above. The media used by persistent storage 1708 also can be removable. For example, a removable hard drive can be used for persistent storage 1708.

Communications unit 1710, in these illustrative examples, provides for communications with other data processing systems or devices. In these illustrative examples, communications unit 1710 is a network interface card.

Input/output unit 1712 allows for input and output of data with other devices that can be connected to data processing system 1700. For example, input/output unit 1712 may provide a connection for user input through at least one of a keyboard, a mouse, or some other suitable input device. Further, input/output unit 1712 may send output to a printer. Display 1714 provides a mechanism to display information to a user.

Instructions for at least one of the operating system, applications, or programs can be located in storage devices 1716, which are in communication with processor unit 1704 through communications framework 1702. The processes of the different embodiments can be performed by processor unit 1704 using computer-implemented instructions, which may be located in a memory, such as memory 1706.

These instructions are referred to as program instructions, computer usable program instructions, or computer-readable program instructions that can be read and executed by a processor in processor unit 1704. The program instructions in the different embodiments can be embodied on different physical or computer-readable storage media, such as memory 1706 or persistent storage 1708.

Program instructions 1718 are located in a functional form on computer-readable media 1720 that is selectively removable and can be loaded onto or transferred to data processing system 1700 for execution by processor unit 1704. Program instructions 1718 and computer-readable media 1720 form computer program product 1722 in these illustrative examples. In the illustrative example, computer-readable media 1720 is computer-readable storage media 1724.

Computer-readable storage media 1724 is a physical or tangible storage device used to store program instructions 1718 rather than a medium that propagates or transmits program instructions 1718. Computer-readable storage media 1724, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1718 can be transferred to data processing system 1700 using a computer-readable signal media. The computer-readable signal media are signals and can be, for example, a propagated data signal containing program instructions 1718. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1720” can be singular or plural. For example, program instructions 1718 can be located in computer-readable media 1720 in the form of a single storage device or system. In another example, program instructions 1718 can be located in computer-readable media 1720 that is distributed in multiple data processing systems. In other words, some instructions in program instructions 1718 can be located in one data processing system while other instructions in program instructions 1718 can be located in one data processing system. For example, a portion of program instructions 1718 can be located in computer-readable media 1720 in a server computer while another portion of program instructions 1718 can be located in computer-readable media 1720 located in a set of client computers.

The different components illustrated for data processing system 1700 are not meant to provide architectural limitations to the manner in which different embodiments can be implemented. In some illustrative examples, one or more of the components may be incorporated in or otherwise form a portion of, another component. For example, memory 1706, or portions thereof, may be incorporated in processor unit 1704 in some illustrative examples. In other examples, more than one processor unit can be present. The different illustrative embodiments can be implemented in a data processing system including components in addition to or in place of those illustrated for data processing system 1700. Other components shown in FIG. 17 can be varied from the illustrative examples shown. The different embodiments can be implemented using any hardware device or system capable of running program instructions 1718.

Thus, illustrative embodiments of the present invention provide a computer implemented method, computer system, and computer program product for managing processing requests. A computer system receives a request. The computer system determines a node fingerprint for nodes in an execution plan for processing the request. The computer system determines an edge fingerprint for edges in the execution plan for processing the request. The computer system compares the node fingerprint and the edge fingerprint with node fingerprints and edge fingerprints for historical requests to form a comparison. The computer system predicts resource requirements for processing the request based on the comparison.

For example, the illustrated examples predict the resource requirements of previously unseen jobs or queries. Instead of relying on exact hashing, the illustrative examples employ a fuzzy hashing technique that allows for approximate matching between the directed acyclic graphs for execution plans for new requests and directed acyclic graphs for execution plans for previously executed queries. By evaluating structural similarities and key attributes within the directed acyclic graphs for execution plans, the illustrative examples enable inferring resource needs even in the absence of an exact historical match. This feature significantly enhances the predictability, scalability, and efficiency of workload management systems for data processing engines.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for managing processing of requests, the method comprising:
receiving, by a computer system, a request;
determining, by the computer system, a node fingerprint for nodes in an execution plan for processing the request;
determining, by the computer system, an edge fingerprint for edges in the execution plan for processing the request;
comparing, by the computer system, the node fingerprint and the edge fingerprint with node fingerprints and edge fingerprints for historical requests to form a comparison; and
predicting, by the computer system, resource requirements for processing the request based on the comparison.

2. The method of claim 1 further comprising:
determining, by the computer system, the execution plan for the request in response to receiving the request, wherein the execution plan comprises the nodes and the edges connecting the nodes.

3. The method of claim 1 further comprising:
scheduling, by the computer system, processing of the request based on the resource requirements predicted for processing the request.

4. The method of claim 3, further comprising:
classifying, by the computer system, tasks for performing the request to form a classification of the tasks in response to scheduling the request; and
dispatching, by the computer system, the tasks for the request based on the classification of the tasks.

5. The method of claim 1, wherein predicting, by the computer system, the resource requirements for processing the request comprises:
identifying, by the computer system, a prior request having a recorded node fingerprint and a recorded edge fingerprint in the comparison with a similarity metric within a similarity threshold of the node fingerprint and the edge fingerprint; and
predicting, by the computer system, the resource requirements for the request using historical resources used to process the prior request.

6. The method of claim 5 further comprising:
adjusting, by the computer system, the historical resources based on actual resource usage from processing the request.

7. The method of claim 1, wherein predicting, by the computer system, the resource requirements for processing the request comprises:
predicting, by the computer system, the resource requirements for the request using a fallback mechanism in response to an absence of a prior request having a recorded node fingerprint and a recorded edge fingerprint in the comparison with a similarity metric within a similarity threshold of the node fingerprint and the edge fingerprint.

8. The method of claim 1, wherein determining, by the computer system, the node fingerprint comprises:
identifying, by the computer system, properties of each node;
constructing, by the computer system, n-grams for each node, wherein the n-grams represent groupings of node properties;
generating, by the computer system, initial hashes for the n-grams for each node; and
aggregating, by the computer system, the initial hashes generated for each node to form the node fingerprint.

9. The method of claim 1, wherein determining, by the computer system, the edge fingerprint comprises:
constructing, by the computer system, a bitmap for each edge in the edges to form bitmaps for edges, wherein each bitmap represents properties of an edge; and
aggregating, by the computer system, the bitmaps for the edges to form the edge fingerprint.

10. A computer system comprising:
a processor set;
a set of one or more computer-readable storage media; and
program instructions, collectively stored in the set of one or more storage media to cause the processor set to perform operations comprising:
receiving a request;
determining a node fingerprint for the nodes in an execution plan for processing the request;
determining an edge fingerprint for edges in the execution plan for processing the request;
comparing the node fingerprint and the edge fingerprint with node fingerprints and edge fingerprints for historical requests to form a comparison; and
predicting resource requirements for processing the request based on the comparison.

11. The computer system of claim 10 further comprising:
determining the execution plan for the request in response to receiving the request, wherein the execution plan comprises the nodes and the edges connecting the nodes.

12. The computer system of claim 10, wherein the operations further comprise:
scheduling processing of the request based on the resource requirements predicted for processing the request.

13. The computer system of claim 12, wherein the operations further comprise:
classifying tasks for performing the request to form a classification of the tasks in response to scheduling the request; and
dispatching the request based on the classification of the tasks.

14. The computer system of claim 10, wherein predicting the resource requirements for processing the request comprises:
identifying a prior request having a recorded node fingerprint and a recorded edge fingerprint in the comparison with a similarity metric within a similarity threshold of the node fingerprint and the edge fingerprint; and
predicting the resource requirements for the request using historical resources used to process the prior request.

15. The computer system of claim 14, wherein the operations further comprise:
adjusting the historical resources based on actual resource usage from processing the request.

16. The computer system of claim 10, wherein predicting the resource requirements for processing the request comprises:
predicting the resource requirements for the request using a fall back mechanism in response to an absence of a prior request having a recorded node fingerprint and a recorded edge fingerprint in the comparison with a similarity metric within a similarity threshold of the node fingerprint and the edge fingerprint.

17. The computer system of claim 10, wherein determining the node fingerprint comprises:
identifying properties of each node;
constructing n-grams for each node, wherein the n-grams represent groupings of node properties;
generating initial hashes for the n-grams for each node; and
aggregating the initial hashes generated for each node to form the node fingerprint.

18. The computer system of claim 10, wherein determining the edge fingerprints comprises:
constructing a bitmap for each edge in the edges to form bitmaps for the edges, wherein each bitmap represents attributes of an edge; and
aggregating the bitmaps for the edges to form the edge fingerprint.

19. A computer program product for managing processing of requests, the computer program product comprising:
a set of one or more computer-readable storage media; and
program instructions stored on the set of one or more storage media to perform operations comprising:
determining a node fingerprint for the nodes in an execution plan for processing the request;
determining an edge fingerprint for the edges in the execution plan for processing the request;
comparing the node fingerprint and the edge fingerprint with node fingerprints and edge fingerprints for historical requests to form a comparison; and
predicting resource requirements for processing the request based on the comparison.

20. The computer program product of claim 19, wherein the operations further comprise:
determining the execution plan for the request in response to receiving the request, wherein the execution plan comprises the nodes and the edges connecting the nodes.
